(19) United States
(12) Patent Application Publication
(10) Pub. No.: US 2022/0029689 A1
(43) Pub. Date: Jan. 27, 2022

(54) First Node and Methods Therein in a Wireless Communications Network

(71) Applicant: Telefonaktiebolaget LM Ericsson (publ), Stockholm (SE)

(72) Inventor: Marius Cismasu, Järfälla (SE)

(21) Appl. No.: 17/311,761

(22) PCT Filed: Dec. 18, 2018
(86) PCT No.: PCT/SE2018/051332

§ 371 Date: Jun. 8, 2021

(51) Int. Cl. H04B 7/06; H04W 16/28

(52) U.S. Cl. CPC H04B 7/0695; H04B 7/0639; H04W 16/28; H04B 7/0617; H04B 7/0634

(57) ABSTRACT

A method performed by a first node for selecting a beam for a data transmission between a Multiple In Multiple Out (MIMO) antenna system used by the first node, and a second node in a wireless communications system is provided. The first node obtains (202) a direction from a reference point of the MIMO antenna system to the second node, based on location data defining a location of the second node. The first node then selects (204) a beam among available beams in the MIMO antenna system for a subsequent transmission to or from the second node. The beam is selected such that an angle between the obtained direction and a main lobe direction of the beam that is selected provides the smallest angle among the available beams in the MIMO antenna system.

### TECHNICAL FIELD

Embodiments herein relate to a first node and methods therein. In some aspects, they relate to selecting a beam for a data transmission from a Multiple In Multiple Out (MIMO) antenna system used by the first node to a second node in a wireless communications system.

### BACKGROUND

In a typical wireless communication network, wireless devices, also known as wireless communication devices, mobile stations, stations (STA) and/or User Equipments (UE), communicate via a Local Area Network such as a WiFi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in 5th Generation (5G). A service area or cell area is a geographical area where radio coverage is provided by the radio network node. The radio network node communicates over an air interface operating on radio frequencies with the wireless device within range of the radio network node. The radio network node communicates to the wireless device in DownLink (DL) and from the wireless device in UpLink (UL).

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3rd Generation (3G) networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of machine to machine communication, also known as the Internet of things, aiming at lower cost, lower battery consumption and lower latency than 4G equipment.

The content of the present disclosure is applicable to Full-Dimension Multiple-Input Multiple-Output (FD-MIMO) radio communications systems. Many antennas, that comprise complex multi-antenna systems, are available at least at base station sites, also referred to as network nodes, in wireless communications systems. The presence of such complex antenna systems in a transmission-reception chain allows improvements in spectral and energy efficiency. However, the management of the large number of antennas requires additional processing in the transmission chain.

When many antennas are available in a transmission chain, two approaches appear as most useful for increasing the information capacity of the data link:

The first approach is to increase the power at the reception site using the antenna array gain. This approach, called beamforming, focuses more electromagnetic energy radiated from the transmit antennas in a direction of space, generating a higher receiver power.

The second approach is to transmit multiple parallel data streams on the same frequency band, at the same time, in different spatial directions. Spatial multiplexing uses different propagation paths through the spatial physical environment to send independent data streams.

Beamforming appears as a direct possibility to increase the capacity in the Shannon-Hartley theorem, which implies to increase received power without increasing noise. Spatial multiplexing became more popular with the advance of technology that allows implementation of MIMO systems that can discriminate multiple spatial paths.

Beamforming is put in practice most easily by feeding all antennas with the same signal, phase and/or amplitude shifted differently to each of the antennas. Without limiting generality, it is considered a typical beamforming transmission link with one receive antenna. This link may be described with the equation.

y=HWx+n

where y is the signal received, H is the channel matrix, W is the beamforming weights matrix also referred to as precoding matrix, x is the signal transmitted, and n is the noise; H and W are matrices with dimensions given by the system configuration, e.g., number of antennas.

Precoding matrix selection algorithms are a fundamental part to make use of the full potential of beamforming. Such algorithms select the beamforming weights matrices, W, that optimize the transmission with respect to some performance metric. Many precoding matrix selection algorithms rely on transmission of known reference signals that are used at the reception site to solve the optimization problem that gives the optimum precoding matrix. This optimum precoding matrix information is then fed back to the transmission site and used for subsequent transmissions.

Two algorithms may be considered for determining the precoding information:

One is to use non-precoded Channel State Information—Reference Signals (CSI-RS) transmitted from each antenna. In other words, the reference signals are not beamformed but broadcasted in the entire cell. In this case, the reception site observes the reference signals and calculates precoding weights that maximize a performance criterion, e.g., the received power. Precoding weights when used herein are those weights that, when applied to the received reference signals, maximize the performance criterion considered; they must be translated by the transmission site into beamforming weights. The reception site then feeds back these weights, or an indicator of the appropriate set of weights, to the transmission site for use in subsequent transmissions. The calculation may be as simple as trying all precoding matrices and selecting the one which maximizes the performance criterion.

Another is to use beamformed CSI-RS, the reception site then observes which beam gives the maximum performance and sends back its index to the transmission site.

The number of computations needed to determine the optimum precoding matrix increases as the number of antennas and beams increases and thereby the complexity, this a problem. As an example, consider the following optimization problem, representative of the problem to determine precoding matrix information:

$${j}^{*} = arg {max}_{j} {\vert {\overline{h}}^{H} {v}_{j} \vert}^{2}$$

here j* is the index of the optimum beam, j spans the number of beams, h̅^{H} is the Hermitian transpose of the estimated channel, and v₁ is the antenna weights matrix for beam j. The main contributors to complexity are the channel estimate which needs to be calculated before the precoding matrix can be calculated and the explicit use of all antenna weights.

### SUMMARY

An object of embodiments herein is to improve the performance of a wireless communications network using multiple antenna systems.

According to an aspect of embodiments herein, the object is achieved by a method performed by a first node for selecting a beam for a data transmission between a Multiple In Multiple Out, MIMO, antenna system used by the first node, and a second node in a wireless communications system. The first node obtains a direction from a reference point of the MIMO antenna system to the second node, based on location data defining a location of the second node. The first node then selects a beam among available beams e.g. for transmission or reception, in the MIMO antenna system for a subsequent transmission to or from the second node. The beam is selected such that an angle between the obtained direction and a main lobe direction of the beam that is selected provides the smallest angle among the available beams in the MIMO antenna system.

According to a another aspect of embodiments herein, the object is achieved by a first node configured to select a beam for a data transmission between a Multiple In Multiple Out, MIMO, antenna system used by the first node, and a second node in a wireless communications system. The first node is configured to:

Obtain a direction from a reference point of the MIMO antenna system to the second node, based on location data defining a location of the second node.

Select a beam among available beams in the MIMO antenna system for a subsequent transmission to or from the second node. The beam is selected such that an angle between the obtained direction and a main lobe direction of the beam that is selected provides the smallest angle among the available beams in the MIMO antenna system.

Since the direction between the first node and second node is obtained based on location data, a beam can be selected such that an angle between the obtained direction from the reference point of the MIMO antenna system to the second node and a main lobe direction of the beam that is selected provides the smallest angle among the beams available in the MIMO antenna system. This results in a selected beam whose main lobe direction is closest to the obtained direction. In this way, the complexity is smaller than usual feedback methods that rely on the channel estimate for computations, which in turn results in energy savings.

Some advantages identified for this beam selection method comprises:

The battery life is improvement on both the first node side and the second node side.

The reporting of precoding matrix information may be switched off or have a reduced frequency.

UE hardware resources may be released, at least partly, for executing additional procedures or for saving energy.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting embodiments of a method in a first node.

FIG. 3 is a schematic block diagram illustrating embodiments of a wireless communications network.

FIG. 4 is a flowchart depicting embodiments of a method in a first node.

FIG. 5a is a schematic block diagram illustrating embodiments of a first node.

FIG. 5b is a schematic block diagram illustrating embodiments of a first node.

FIG. 6 schematically illustrates a telecommunication network connected via an intermediate network to a host computer.

FIG. 7 is a generalized block diagram of a host computer communicating via a base station with a user equipment over a partially wireless connection.

FIGS. 8-11 are flowcharts illustrating methods implemented in a communication system including a host computer, a base station and a user equipment.

### DETAILED DESCRIPTION

According to an example, embodiments herein may comprise wireless communication systems, methods of choosing beam or precoding matrix index in full-dimension MIMO, and may relate to MIMO, Full-Dimension MIMO (FD-MIMO), feedback channel, Common Reference Signal (CRS), Demodulation Reference Signal (DMRS), CSI-RS, Precoding Matrix Indicator (PMI), Active Antenna System (AAS)), Grid of Beams (GoB).

As mentioned above the prior art solutions for selecting beams are very complex because of the channel estimates that need to be calculated before the precoding matrix can be calculated in order to select a beam, and the explicit use of all antenna weights.

Some example embodiments herein provide selection of beams, also referred to as precoding weights, in a first node based on a geometrical computation using the location of the first node and a second node, whereof the first node is aware of its own location. In contrast, the beam selection in prior art methods is made by using reference signals transmitted to the reception site, which uses them in a quality estimation for the reception; the result of this estimation is then fed back to the transmission site.

Thus, instead of the complex channel estimates, embodiments herein make use of the direction from the transmitting node to the sending node, or the direction from the sending node to the transmitting node, also referred to as peer nodes. This direction from one to the other peer node is used as a reference to find and select a beam with a main lobe direction that most agrees with the direction to the peer node. The selected beam will then be used for transmitting or receiving a data transmission. In this way, a mainly geometrical calculation can be used.

In an example of embodiments herein, the direction between the first node and a second node is determined using location data, e.g., geographic coordinates. A beam is then selected whose main lobe direction is closest to the direction between the first node and the second node, e.g., between a network node such as an eNB and a UE.

Some example embodiments herein provide a method for computing Precoding Matrix Information in Full Dimension MIMO.

Embodiments herein are directly applicable, but not limited, to beamforming.

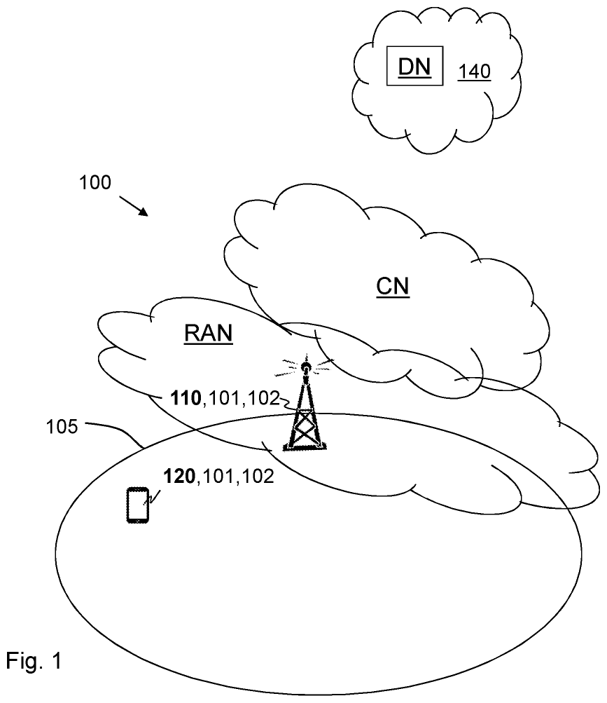

FIG. 1 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

Any description with reference to a particular Radio Access technology (RAT) is used for illustration purposes. The embodiments are applicable to any RAT or multi-RAT system where the UE receives information-carrying signals from multiple antennas, e.g., systems supporting MIMO—UTRA/HSPA, LTE FDD/TDD, WiFi, WiMax, CDMA2000 etc. The methods described herein are applicable for any number of antennas considered.

Network nodes and UEs operate in the wireless communications network 100. Embodiments herein relate to a first node 101 and a second node 102, which both are radio nodes. In FIG. 1, the first node 101 is represented by a network node 110 and the second node 102 is represented by a UE 120. However, according to embodiments herein the first node 101 is a node using a MIMO antenna system and therefore it does not matter whether the first node is network node or a UE as long as it uses MIMO antenna system. Consequently it may as well be the other way around where the first node 101 is represented by a UE and the reception node 120 is represented by a network node.

In scenarios herein, the network node 110 which may be the first node 101 or the second node 102, provides a cell 105. The cell 105 may also be referred to as a service area, beam or a group of beams multiple TRPs, or multiple BWPs. The cell 105 may in some embodiments be configured with multiple UL carries such as multiple beams, multiple TRPs, or multiple BWPs. E.g. an NR cell configured with both a SUL carrier and an NR UL carrier.

The network node 110 is a radio node, e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point or an Access Point Station (AP STA), an access controller, or any other network unit capable of communicating with a UE within the cell 105 served by the network node 110 depending e.g. on the radio access technology and terminology used. The network node 110 may be referred to as a serving radio network node and communicates with a UE 120 with Downlink (DL) transmissions to the UE 120 in and Uplink (UL) transmissions from the UE 120.

In some embodiments the non-limiting term radio network node or simply network node 110 is used. This term refers to any type of network element serving UEs and/or connected to other network nodes or network elements; it also refers to any network element from where a UE receives an information signal. Examples of radio network nodes are: Node B, base station (BS), multi-standard radio (MSR) node such as MSR BS, Evolved Node B (eNB), network controller, radio network controller (RNC), base station controller (BSC), relay, base transceiver station (BTS), access point (AP), transmission points, transmission nodes, remote radio unit (RRU), remote radio head (RRH), nodes in distributed antenna systems (DAS), etc.

Wireless devices such as e.g. the UE 120 operate in the wireless communications network 100. The UE120 which as mentioned above may be the first node 101 or the second node 102, is a radio node and may e.g. be an NR device a mobile station, a wireless terminal, an NB-IoT device, an eMTC device, a CAT-M device, a WiFi device, an LTE device and an a non-access point (non-AP) STA, a STA, that communicates via a base station such as e.g. the network node 110, one or more Access Networks (AN), e.g. RAN, to one or more core networks (CN). It should be understood by the skilled in the art that “UE” is a non-limiting term which means any terminal, wireless communication terminal, user equipment, Device to Device (D2D) terminal, or node e.g. smart phone, laptop, mobile phone, sensor, relay, mobile tablets or even a small base station communicating within a cell.

In some embodiments the non-limiting term user equipment (UE) is used e.g. for the UE 120. This term refers to any type of wireless device communicating with a radio network node in a cellular or mobile communication system. Examples of UE are: target device, device to device (D2D) UE, machine type UE or UE capable of machine to machine (M2M) communication, PDA, iPAD, tablet, mobile terminal, smart phone, laptop embedded equipped (LEE), Laptop Mounted Equipment (LME), USB dongle etc.

As mentioned above, the methods according to embodiments herein are performed by the first node 101 which e.g. may be any one out of the network node 110 and the UE 120.

As an alternative, a Distributed Node DN and functionality, e.g. comprised in a cloud 140 as shown in FIG. 1 may be used for performing or partly performing the methods.

The methods are applicable to single carrier as well as to Multicarrier (MC) or Carrier Aggregation (CA) operation of the UE in conjunction with MIMO in which the UE receives and/or transmits data to more than one serving cells using MIMO. The term CA is also called, e.g. interchangeably called, multi-carrier system, multi-cell operation, multi-carrier operation, multi-carrier transmission and/or reception.

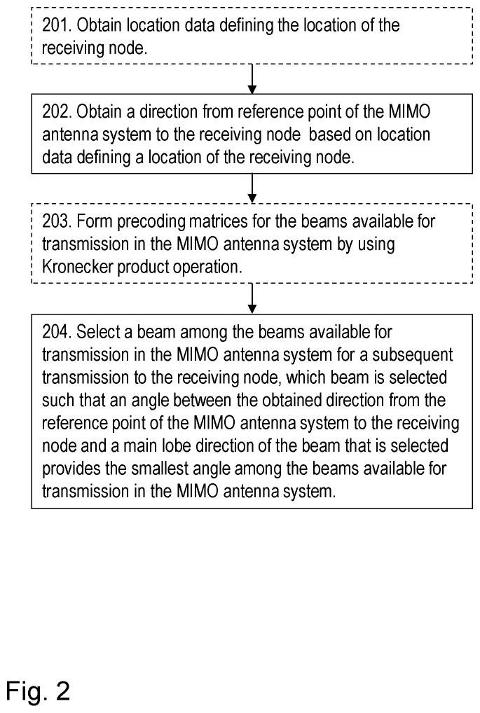

Example embodiments of a method performed by the first node 101 for selecting a beam for a data transmission between a MIMO antenna system used by the first node 101, and a second node 102 in a wireless communications system, will now be described with reference to a flowchart depicted in FIG. 2.

As mentioned above, the first node 101 is represented by the network node 110, and the second node 102 is represented by the UE 120, or the other way around, where the first node 101 is represented by the UE 120, and the second node 102 is represented by the network node 110. Further, the first node 101 may be a transmitting node and the second node 102 may be a receiving node, or the other way around, where the first node 101 is a receiving node, and the second node 102 is a transmitting node of the data transmission.

The MIMO antenna system provides a number of beams that are available for transmissions or for receptions of data transmissions in the wireless communications system 100, to second nodes such as the second node 102. Beamforming when used herein may relate to signal processing which, when applied in a MIMO system, allows focusing more power in a direction of space compared with other directions.

The method comprises the following actions, which actions may be taken in any suitable order. Actions that are optional are presented in dashed boxes in FIG. 2.

Action 201

According to an example scenario, the first node 101 requires to transmit user data, in an upcoming data transmission to the second node 102. E.g. the second node 102 may have requested some data to be delivered to it, e.g., internet data.

It may also be the other way around; the first node 101 requires receiving user data, in an upcoming data transmission from the second node 102.

Embodiments herein uses location data for the second node 102 as a basis for beam selection for the upcoming transmission also referred to as the upcoming data transmission. According to some embodiments, the first node 101 may obtain the location data defining the location of the second node 102 such as coordinates of the second node 102. This may be performed e.g., by retrieving it when stored in the the first node 101, or receiving the second node 102 coordinates from the second node 102. In some embodiments by using an uplink or downlink control channel or an uplink or downlink user data channel.

Action 202

According to the example scenario, the first node 101 will select a beam whose main lobe direction is closest to the direction between the transmission and reception sites, and therefore needs to know this direction. The beam is for transmitting or receiving the data transmission. Thus the first node 101 obtains a direction from a reference point of the MIMO antenna system to the second node 102. This is based on the location data defining the location of the second node 102. This action may in some embodiments relate to Actions 402 and 403 described below. It should be noted that the wording “the direction from the reference point of the MIMO antenna system to the second node 102” shall be interpreted as comprising the direction in the other way around, meaning a direction from the second node 102 to the a reference point of the MIMO antenna system. Both these directions are applicable in embodiments herein.

In some embodiments, the location data comprises coordinates of the second node 102. Coordinates when used herein means any type of information that allows knowing the precise position of the second node 102 on the Earth, e.g., location in a geographic coordinate system such as latitude, longitude and elevation. In some embodiments it may be enough with knowing the location of the second node 102 in the coverage area of a serving network node. In these embodiments, the obtaining of the direction from the reference point of MIMO antenna system to the second node 102, based on the location data may be performed by:

The first node 101 may translate the coordinates of the second node 102 into a position vector of the second node 102, referred to as action 402 below, and normalize the position vector of the second node 102 to obtain the direction from the reference point of MIMO antenna system to the second node 102, referred to as action 403 below.

The position vector of the second node 102, referred to as r_{UE} with coordinates referred to as x_{UE}, y_{UE}, z_{UE} may comprise r_{UE}=(x_{UE}, y_{UE}, z_{UE})^{T}.

The normalizing of the position vector of the second node 102 may then be determined by:

$${\hat{r}}_{U E} = \frac{{r}_{U E}}{\vert {r}_{U E} \vert} = \frac{1}{\sqrt{{x}_{U E}^{2} + {y}_{U E}^{2} + {z}_{U E}^{2}}} ( \begin{matrix}{x}_{U E} \\ {y}_{U E} \\ {z}_{U E}\end{matrix} )$$

Action 203

According to some embodiments the first node 101 forms precoding matrices for the beams available, e.g. for transmission or reception, in the MIMO antenna system by using Kronecker product operation, referred to as action 404 below.

The forming of the precoding matrices for the beams available for transmission in the MIMO antenna system using Kronecker product operation may be determined by:

Wᵢ=Kron(W_{H,m},W_{V,n}),i=1,2, . . . ,N_{PMI}

where Wᵢ, W_{H,m}, W_{V,n} are precoding matrices for a full-dimension, horizontal and vertical domains, respectively, and i is an indicator for the full-dimension precoding matrix associated to a pair m, n, which indicator is a counting rule for precoding matrices. The respective computed unit vector, may be is represented by:

\hat{r}_{PMI,i},i=1,2, . . . ,N_{PMI}.

According to some embodiments herein, the first node 101 computes the respective unit vector in the direction of the main lobe of radiation pattern resulting from applying the precoding matrix of each of the respective formed precoding matrices, referred to as action 405 below. The respective unit vector may then be stored by the first node 101.

Action 204

The first node 101 then selects a beam among available beams e.g. for transmission or reception, in the MIMO antenna system. This may also be referred to as the first node 101 selects a beam out of the number of beams available for transmission in the MIMO antenna system. This is for a subsequent transmission to or from the second node 120. The beam is selected such that an angle between the obtained direction and a main lobe direction of the beam that is selected provides the smallest angle among the available beams in the MIMO antenna system. This may also be referred to as the first node 101 selects the beam wherein the beam direction is closest to the direction towards or from the second node 102. This action may in some embodiments relate to Actions 406 and 407 described below.

The selecting of the beam among the available beams may performed by computing a scalar product. The scalar product is computed based on the normalized position vector of the second node 102 and a unit vector of each respective beam available in the MIMO antenna system, referred to as action 406 below.

In some embodiments, the beam being selected, since an angle between the obtained direction and a main lobe direction of the beam that is selected provides the smallest angle among the available beams in the MIMO antenna system, is the beam where the scalar product is largest among the beams available in the MIMO antenna system, referred to as action 407 below. In short, the beam being selected may be the beam where the scalar product is largest among the scalar products of the available beams.

In some embodiments, the scalar product is represented by a scalar product index. In these embodiments the first node 101 may compute the scalar product based on the normalized position vector of the second node 102 for each respective beam available in the MIMO antenna system, by computing a scalar product index derived from:

sᵢ=\hat{r}_{UE}·\hat{r}_{B,i}=x_{UE}x_{B,i}+y_{UE}y_{B,i}+z_{UE}z_{B,i},i=1,2, . . . ,N_{B}

wherein sᵢ is the scalar product of beam with index i and N_{B} is the number of beams available in the MIMO antenna system.

In some of these embodiments the scalar product index of the selected beam is represented by:

$${i}_{selected} = \begin{matrix}arg max {s}_{i} \\ i\end{matrix}$$

wherein i_{selected} is the largest scalar product index of the selected beam among scalar product indexes of the available beams.

Embodiments herein, such as mentioned above, will now be further described and exemplified. The text below is applicable to and may be combined with any suitable embodiment described above.

Beam Selection, Also Referred to as Precoding Matrix Selection

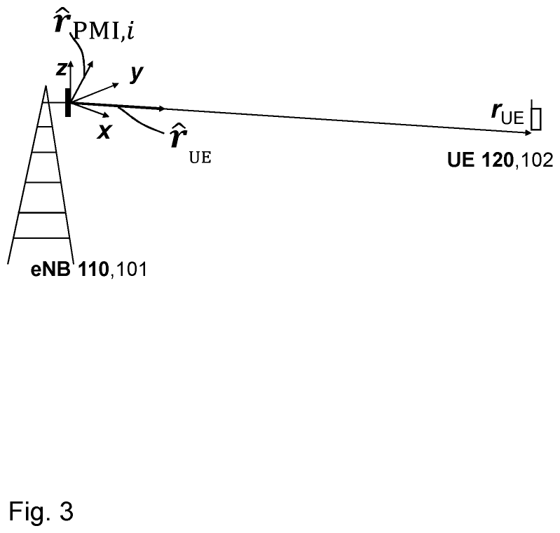

FIG. 3, depicts vectors used in a precoding matrix selection such as the beam selection, based on location information. Consider FIG. 3, where the arrangement of vectors in Three Dimensional (3D) Cartesian space is represented for a transmission between the first node 101 which in this example scenario is the network node 110 referred to as eNB in FIG. 3 and the second node 102 which in this example scenario is the UE 120. However, as mentioned above it may as well be the other way around.

The first node 101 which in the example scenarios below is the network node 110 is referred to as the first node 101, 110. Further, the second node 102 which in the example scenarios below is the UE 120 is referred to as the second node 102, 120.

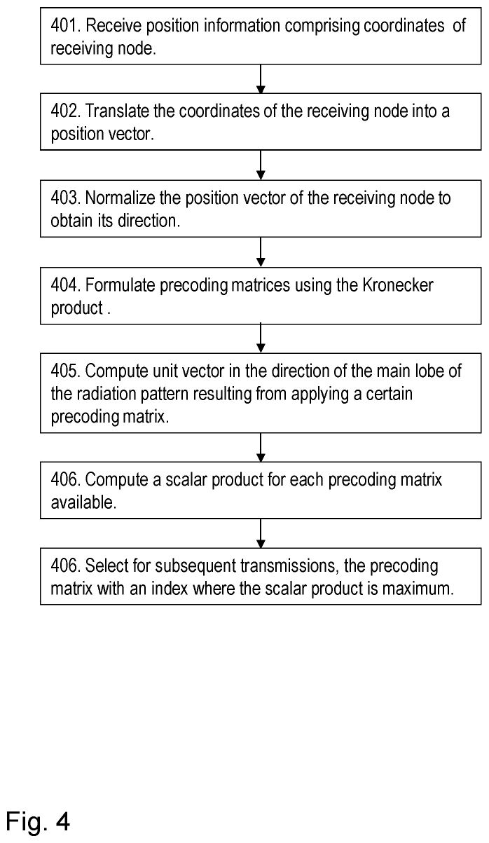

The actions performed at the first node 101, 110 are depicted in FIG. 4 and may in this example comprise the following actions:

1. The first node 101, 110 receives the position information of the second node 102, 120, e.g., coordinates of the second node 102, 120. This relate to Action 401 in FIG. 4.

2. The first node 101, 110 translates the coordinates of the second node 102, 120 into a position vector, r_{UE}=(x_{UE}, y_{UE}, z_{UE})^{T}. For simplification of the description, it is considered that the origin of the Cartesian coordinate system is at the first node 101, 110, more precisely at a reference point of the antenna system of the network node 110, e.g., geometrical or phase centre of the antenna array. This relate to Action 402 in FIG. 4.

3. The first node 101, 110 normalizes the position vector of the second node 102, 120 to obtain its direction:

$${\hat{r}}_{U E} = \frac{{r}_{U E}}{\vert {r}_{U E} \vert} = \frac{1}{\sqrt{{x}_{U E}^{2} + {y}_{U E}^{2} + {z}_{U E}^{2}}} ( \begin{matrix}{x}_{U E} \\ {y}_{U E} \\ {z}_{U E}\end{matrix} )$$

This relate to Action 403 in FIG. 4.

4. The first node 101, 110 computes a scalar product for each precoding matrix/beam available (N_B is the number of beams or precoding matrices available for transmission or reception):

sᵢ=\hat{r}_{UE}·\hat{r}_{B,i}=x_{UE}x_{B,i}+y_{UE}y_{B,i}+z_{UE}z_{B,i},i=1,2, . . . ,N_{B}

This relate to Action 406 in FIG. 4.

5. The first node 101, 110 then selects for subsequent transmissions the beam, in this example referred to as the precoding matrix with the index i_{selected}, where the scalar product is maximum, i.e., the beam direction is closest to the direction of the second node 102, 120.

$${i}_{selected} = \begin{matrix}arg max {s}_{i} \\ i\end{matrix}$$

This relate to Action 407 in FIG. 4.

Method to Compute a Unit Vector Associated with a Precoding Matrix

At step 4 relating to Action 406 in FIG. 4, in the algorithm above, the first node 101, 110 needs the unit vectors associated with each precoding matrix. Therefore, the first node 101, 110 may compute and store these unit vectors for later use. This computation is possible by using radiation patterns of the antenna elements installed at the first node 101, 110 and precoding weights. Without loss of generality it is considered that the first node 101, 110 has identical antenna elements. However, the first node 101, 110 may in some embodiment have non-identical antenna elements In an example of embodiments herein, the radiation pattern of each antenna element is used to find the direction of the main lobe associated with the precoding matrix.

The impact of the arrangement of antenna elements in an array may be described by the two dimensional function array factor,

$${A}_{i} ( θ , φ ) = {\sum }_{m = 1}^{{N}_{t}} {p}_{i , m} {d}_{m} ( θ , φ ) , i = 1 , 2 , . . . , {N}_{B}$$

where p_{i,m} is the m-th precoding weight corresponding to the i-th precoding matrix, and dₘ is an array geometry dependent factor corresponding to the m-th antenna.

The spatial gain pattern of the antenna array is:

Gᵢ(θ,φ)=|Aᵢ(θ,φ)|²G(θ,φ)

where G(θ, φ) is the radiation pattern of the antenna elements.

The direction of the maximum gain for each precoding matrix is found by deciding it from:

$${( θ , φ )}_{max gain , i} = \begin{matrix}arg max {G}_{i} ( θ , φ ) \\ θ , φ\end{matrix} , i = 1 , 2 , . . . , {N}_{B}$$

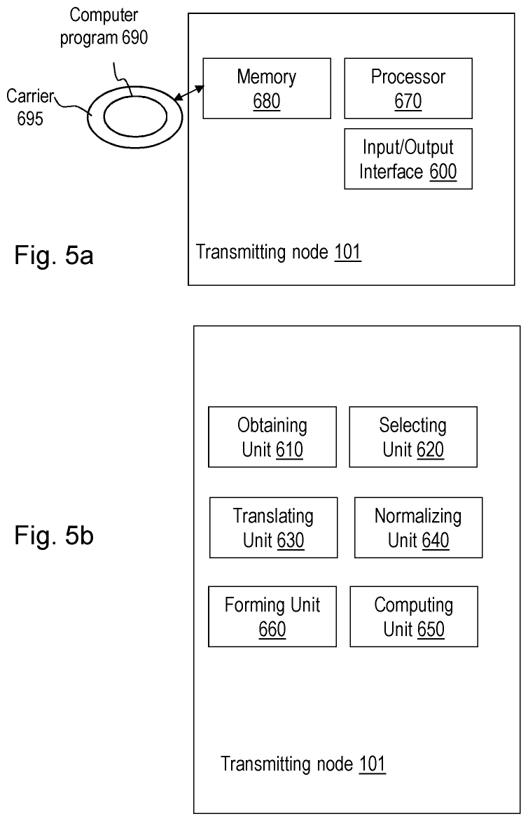

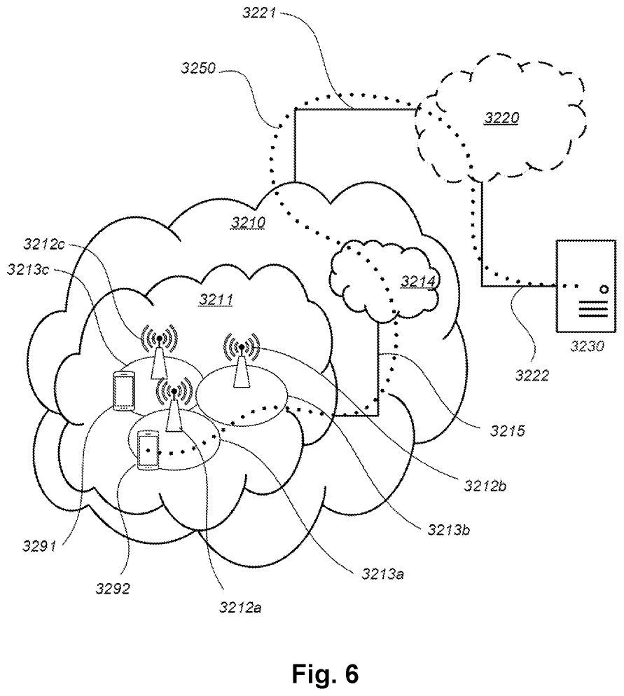

The unit vector \hat{r}_{B,i} involved in the PMI selection for the direction of the maximum gain is computed, see FIG. 5, e.g. by deciding it from.

$${\hat{r}}_{B , i} = ( \begin{matrix}sin {θ}_{max gain , i} cos {φ}_{max gain , i} \\ sin {θ}_{max gain , i} sin {φ}_{max gain , i} \\ cos {θ}_{max gain , i}\end{matrix} ) , i = 1 , 2 , . . . , {N}_{B}$$

Below follows a description of a method to compute the position vector of the second node 102, 120 based on geographic coordinates, according to an example of embodiments herein.

Denote Lat_{UE}, Long_{UE}, Alt_{UE} which refer to the latitude, longitude and altitude of the second node 102, 120. The first node 101, 110 may obtain these coordinates, e.g., by using LTE positioning, a terrestrial beacon system, The Global Positioning System (GPS), Global Navigation Satellite System (GLONASS), etc. It is assumed that the coordinates of the reference point of the MIMO antenna system of the first node 101, 110, Lat_{BS}, Long_{BS}, Alt_{BS} are known at the first node 101, 110. Consider a Cartesian coordinate system with the origin in the reference point of the MIMO antenna system of the first node 101, 110 also referred to as the base station antenna center, and the x, y, and z-axes pointing toward north, west, and zenith, respectively. In this coordinate system the position of the second node 102, 120 is:

$${r}_{U E} = ( \begin{matrix}( L a {t}_{U E} - L a {t}_{B S} ) {\vert}_{r a d i a n s} \cdot {R}_{Earth} \\ ( L o n {g}_{U E} - L o n {g}_{B S} ) {\vert}_{r a d i a n s} \cdot {R}_{Earth} \\ {Alt}_{U E} - {Alt}_{B S}\end{matrix} )$$

where R_{Earth} is the radius of Earth's curvature at the first node 101, 110. Note that the approximation due to the curvature of the Earth made above is negligible in many terrestrial coverage situations. However, this approximation may be corrected with little additional computational effort. Also note that the above formula is valid for the north-western quarter hemisphere of the Earth, due to the definitions of latitude and longitude and their range of values.

Method at the First Node 101, 110 to Compute the PMI in Azimuth and Elevation

Some of the approaches to feedback Channel State Information (CSI) from the second node 102, 120 to the first node 101, 110 rely on splitting the problem in a horizontal and a vertical component, azimuth and elevation domains. Two smaller codebooks with fewer precoding weights are used in each domain. The full-dimension precoding matrix is determined as a Kronecker product between the azimuth and elevation precoding weights vectors. In the following an algorithm to choose PMI using location data according to embodiments herein is described.

For the purpose of this disclosure, the Kronecker product is an operation, C=Kron(A, B), that produces a block matrix where each block of C is the result of multiplying operand B (a matrix) by one of the elements of operand A (a scalar); there are as many blocks as there are elements in A, with the same arrangement as the elements of A.

The actions performed at the first node 101, 110 are depicted in FIG. 4 and may in this example comprise the following actions:

1. The first node 101, 110 receives the position information of the second node 102, 120, e.g., coordinates of the second node 102, 120. This relate to Action 401 in FIG. 4.

2. The first node 101, 110 translates the coordinates of the second node 102, 15120 into a position vector, r_{UE}=(x_{UE}, y_{UE}, z_{UE})^{T}. For simplification of the description, it is considered that the origin of the Cartesian coordinate system is at the first node 101, 110, more precisely at the reference point of the MIMO antenna system of the first node 101, 110 also referred to as a reference point of the antenna system of the first node 101, 110, e.g., geometrical or phase center of the antenna array. This relate to Action 402 in FIG. 204.

3. The first node 101, 110 normalizes the position vector of the second node 102, 120 to obtain its direction:

$${\hat{r}}_{U E} = \frac{{r}_{U E}}{\vert {r}_{U E} \vert} = \frac{1}{\sqrt{{x}_{U E}^{2} + {y}_{U E}^{2} + {z}_{U E}^{2}}} ( \begin{matrix}{x}_{U E} \\ {y}_{U E} \\ {z}_{U E}\end{matrix} )$$

This relate to Action 403 in FIG. 4.

4. The first node 101, 110 forms the precoding matrices using the Kronecker product, N_{PMI} is the length of the PMI table.

Wᵢ=Kron(W_{H,m},W_{V,n}),i=1,2, . . . ,N_{PMI}

where Wᵢ, W_{H,m}, W_{V,n} are the precoding matrices for the full-dimension, horizontal and vertical domains, respectively, and i is an indicator for the full-dimension precoding matrix associated to the pair (m, n), i.e., i is a counting rule for precoding matrices. This relate to Action 404 in FIG. 4.

5. The first node 101, 110 computes a unit vector in the direction of the main lobe of the radiation pattern resulting from applying a certain precoding matrix, \hat{r}_{PMI,i}, i=1, 2, . . . , N_{PMI}, see above. This relate to Action 405 in FIG. 4.

6. The first node 101, 110 computes a scalar product sᵢ for each precoding matrix available.

sᵢ=\hat{r}_{UE}·\hat{r}_{PMI,i}=x_{UE}x_{PMI,i}+y_{UE}y_{PMI,i}+z_{UE}z_{PMI,i},i=1,2, . . . ,N_{PMI}

This relate to Action 406 in FIG. 4.

7. The first node 101, 110 then selects, for subsequent transmissions, the precoding matrix with the index i_{selected}, where the scalar product is maximum, i.e., the beam direction is closest to the direction of the second node 102, 120.

$${i}_{s e l e c t e d} = \begin{matrix}arg max {s}_{i} \\ i\end{matrix}$$

This relate to Action 407 in FIG. 4.

Similar algorithms may be employed when only either the elevation or the azimuth domain precoding matrices need to be determined.

To perform the method actions described above, the first node 101 may comprise the arrangement depicted in FIGS. 5a and 5b. The first node 101 is configured to select a beam for a data transmission between a MIMO antenna system used by the first node 101, and a second node 102 in a wireless communications system 100. As mentioned above, the first node 101 may be according to any one out of:

The first node 101 is represented by a network node, and the second node 102 is represented by a User Equipment, or the first node 101 is represented by a User Equipment, and the second node 102 is represented by a network node.

The first node 101 may comprise an input and output interface 600 configured to communicate e.g. with the network node 110 if being the UE 120 and with the UE 120 if being the network node 110. The input and output interface may comprise a wireless receiver (not shown) and a wireless transmitter (not shown).

The first node 101 is configured to, e.g. by means of an obtaining unit 610 in the first node 101, obtain a direction from a reference point of the MIMO antenna system to the second node 120, based on location data defining a location of the second node 120.

The first node 101 is configured to, e.g. by means of a selecting unit 620 in the first node 101, select a beam among available beams in the MIMO antenna system for a subsequent transmission to or from the second node 120. The beam is selected such that an angle between the obtained direction and a main lobe direction of the beam that is selected provides the smallest angle among the available beams in the MIMO antenna system.

In some embodiments, the location data is adapted to comprise coordinates of the second node 120. In these embodiments, the first node 101 may further be configured to, e.g. by means of an obtaining unit 610 in the first node 101, obtain the direction from the reference point of MIMO antenna system to the second node 120 based on the location data by translating the coordinates of the second node 102 into a position vector of the second node 120, e.g. by means of a translating unit 630 in the first node 101, and further normalizing the position vector of the second node 102 to obtain the direction from the reference point of MIMO antenna system to the second node 120, e.g. by means of a normalizing unit 640 in the first node 101.

In some embodiments, the position vector r_{UE} of the second node 102 with coordinates x_{UE}, y_{UE}, z_{UE} comprises: r_{UE}=(x_{UE}, y_{UE}, z_{UE})^{T}.

In these embodiments, the first node 101 may further is configured to, e.g. by means of a normalizing unit 640 in the first node 101, normalize the position vector of the second node 102 by determining it from:

$${\hat{r}}_{U E} = \frac{{r}_{U E}}{\vert {r}_{U E} \vert} = \frac{1}{\sqrt{{x}_{UE}^{2} + {y}_{UE}^{2} + {z}_{UE}^{2}}} ( \begin{matrix}{x}_{UE} \\ {y}_{UE} \\ {z}_{UE}\end{matrix} )$$

The first node 101 may further being configured to, e.g. by means of a forming unit 650 in the first node 101, form precoding matrices for the beams available in the MIMO antenna system using Kronecker product operation.

The first node 101 may further being configured to, e.g. by means of a computing unit 650 in the first node 101, compute a respective unit vector in the direction of the main lobe of radiation pattern resulting from applying the precoding matrix of each of the respective formed precoding matrices.

The first node 101 may further be configured to, e.g. by means of the forming unit 5660 in the first node 101, form the precoding matrices for the beams available for transmission in the MIMO antenna system using Kronecker product operation, by determining it from: Wᵢ=KronW_{H,m}, W_{V,n}, i=1, 2, . . . , N_{PMI}, where Wᵢ, W_{H,m}, W_{V,n} are precoding matrices for a full-dimension, horizontal and vertical domains, respectively, and i is an indicator for the full-dimension precoding matrix associated to a pair m, n, which indicator is adapted to be a counting rule for precoding matrices. In these embodiments, the respective computed unit vector is adapted to be represented by: \hat{r}_{PMI,i}, i=1, 2, . . . , N_{PMI}.

The first node 101 may in some embodiments be configured to, e.g. by means of the selecting unit 620 in the first node 101, select the beam among the beams available in the MIMO antenna system by compute a scalar product based on the normalized position vector of the second node 102 and a unit vector of each respective beam available in the MIMO antenna system e.g. by means of the computing unit 650 in the first node 101.

In some embodiments the beam adapted to be selected since the angle between the obtained direction from the reference point of the MIMO antenna system to the second node 102 and a main lobe direction of the beam that is selected provides the smallest angle among the beams available, is adapted to be the beam where the scalar product is largest among the beams available in the MIMO antenna system.

The scalar product may in some embodiments be represented by a scalar product index. In these embodiments, the first node 101 may further be configured to, e.g. by means of the computing unit 650 in the first node 101, compute the scalar product based on the normalized position vector of the second node 102 for each respective beam available in the MIMO antenna system, by computing a scalar product index derived from:
sᵢ=\hat{r}_{UE}=x_{UE}x_{B,i}+y_{UE}y_{B,i}+z_{UE}z_{B,i},i=1, 2, . . . , N_{B}, wherein sᵢ is the scalar product of beam with index i and N_{B} is the number of beams available in the MIMO antenna system.

In these embodiments the scalar product index of the selected beam is adapted to be represented by:

$${i}_{s e l e c t e d} = \begin{matrix}arg max {s}_{i} \\ i\end{matrix} ,$$

wherein i_{selected} is the largest scalar product index of the selected beam among scalar product indexes of the available beams.

Those skilled in the art will also appreciate that the units in the first node 101 mentioned above may refer to a combination of analog and digital circuits, and/or one or more processors configured with software and/or firmware, e.g. stored in the first node 101 that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

The embodiments herein may be implemented through a respective processor or one or more processors, such as a processor 670 of a processing circuitry in the first node 101 depicted in FIG. 5a, together with respective computer program code for performing the functions and actions of the embodiments herein. The program code mentioned above may also be provided as a computer program product, for instance in the form of a data carrier carrying computer program code for performing the embodiments herein when being loaded into the first node 101. One such carrier may be in the form of a CD ROM disc. It is however feasible with other data carriers such as a memory stick. The computer program code may furthermore be provided as pure program code on a server and downloaded to the first node 101.

The first node 101 may further comprise a memory 680 comprising one or more memory units. The memory 680 comprises instructions executable by the processor in the first node 101.

The memory 680 is arranged to be used to store e.g. location data, unit vectors, user data, and applications etc. to perform the methods herein when being executed in the first node 101.

In some embodiments, a respective computer program 690 comprises instructions, which when executed by the respective at least one processor 670, cause the at least one processor 670 of the first node 101 to perform the actions above.

In some embodiments, a respective carrier 695 comprises the respective computer program 690, wherein the carrier 695 is one of an electronic signal, an optical signal, an electromagnetic signal, a magnetic signal, an electric signal, a radio signal, a microwave signal, or a computer-readable storage medium.

Further Extensions and Variations

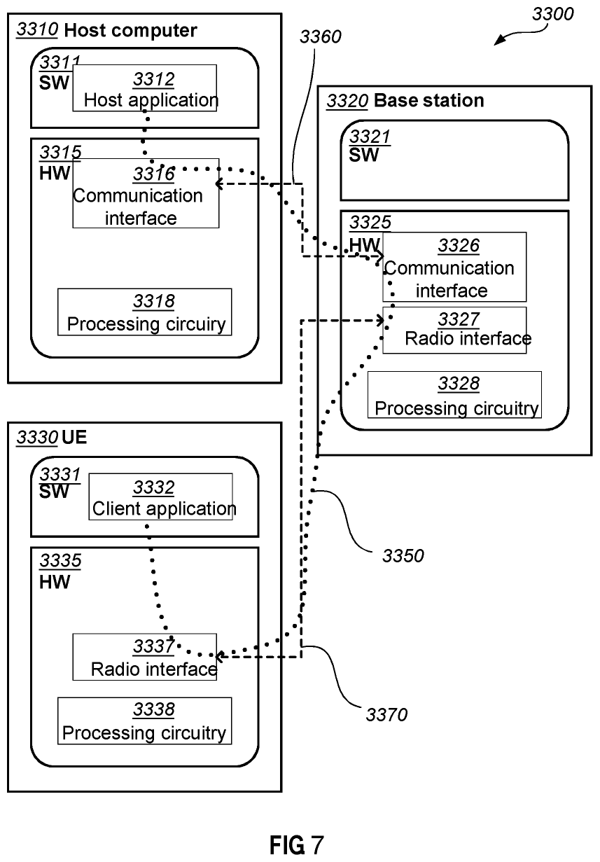

With reference to FIG. 6, in accordance with an embodiment, a communication system includes a telecommunication network 3210 such as the wireless communications network 100, e.g. a NR network, such as a 3GPP-type cellular network, which comprises an access network 3211, such as a radio access network, and a core network 3214. The access network 3211 comprises a plurality of base stations 3212a, 3212b, 3212c, such as the network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the UE 120 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 303221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 6 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

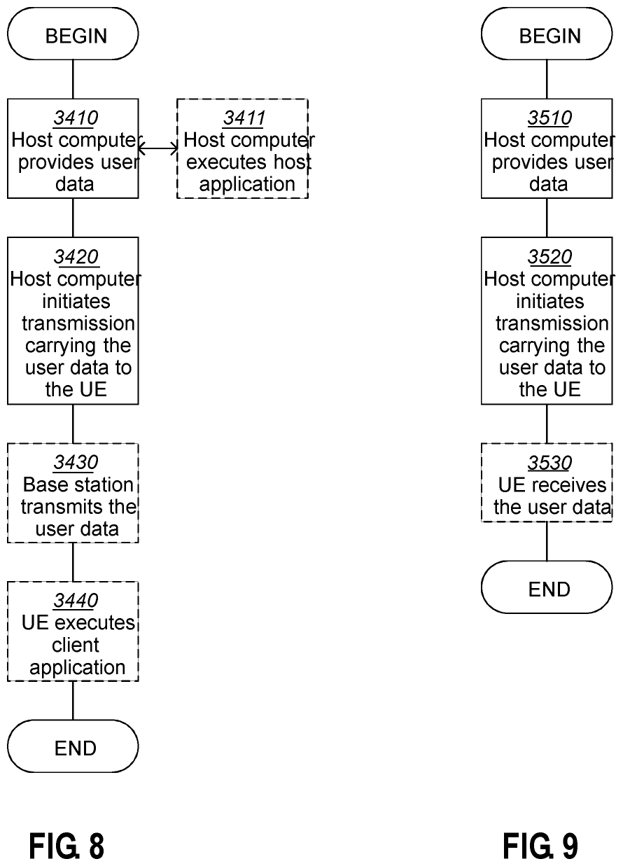

Example implementations, in accordance with an embodiment, of the UE, base station and host computer discussed in the preceding paragraphs will now be described with reference to FIG. 7. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 7) served by the base station 3320. The communication interface 3326 may be configured to facilitate a connection 3360 to the host computer 3310. The connection 3360 may be direct or it may pass through a core network (not shown in FIG. 7) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 7 may be identical to the host computer 3230, one of the base stations 3212a, 3212b, 3212c and one of the UEs 3291, 3292 of FIG. 6, respectively. This to say, the inner workings of these entities may be as shown in FIG. 7 and independently, the surrounding network topology may be that of FIG. 6.

In FIG. 7, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

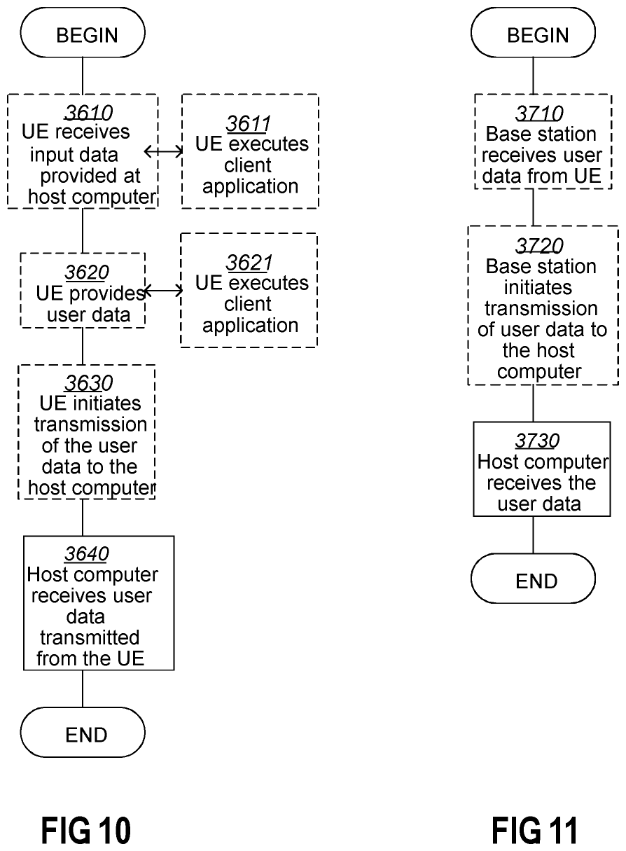

FIG. 8 is a flowchart illustrating a method implemented in a communication system, in accordance with one embodiment. The communication system includes a host computer, a base station such as a AP STA, and a UE such as a Non-AP STA which may be those described with reference to FIG. 6 and FIG. 7. For simplicity of the present disclosure, only drawing references to FIG. 8 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 9 is a flowchart illustrating a method implemented in a communication system, in accordance with one embodiment. The communication system includes a host computer, a base station such as a AP STA, and a UE such as a Non-AP STA which may be those described with reference to FIG. 6 and FIG. 7. For simplicity of the present disclosure, only drawing references to FIG. 9 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

FIG. 10 is a flowchart illustrating a method implemented in a communication system, in accordance with one embodiment. The communication system includes a host computer, a base station such as a AP STA, and a UE such as a Non-AP STA which may be those described with reference to FIG. 6 and FIG. 7. For simplicity of the present disclosure, only drawing references to FIG. 10 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 11 is a flowchart illustrating a method implemented in a communication system, in accordance with one embodiment. The communication system includes a host computer, a base station such as a AP STA, and a UE such as a Non-AP STA which may be those described with reference to FIG. 6 and FIG. 7. For simplicity of the present disclosure, only drawing references to FIG. 11 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1-18. (canceled)

19. A method, performed by a first node, for selecting a beam for a data transmission between a Multiple In Multiple Out (MIMO) antenna system used by the first node and a second node in a wireless communications system, the method comprising the first node:
obtaining a direction from a reference point of the MIMO antenna system to the second node, based on location data defining a location of the second node;
selecting a beam among available beams in the MIMO antenna system for a subsequent transmission to or from the second node, wherein the beam that is selected is selected such that an angle between the obtained direction and a main lobe direction of the beam that is selected provides the smallest angle among the available beams in the MIMO antenna system.

20. The method of claim 19:
wherein the location data comprises coordinates of the second node;
wherein the obtaining the direction comprises:
translating the coordinates of the second node into a position vector of the second node; and
normalizing the position vector of the second node to obtain the direction from the reference point of MIMO antenna system to the second node.

21. The method of claim 20:
wherein the position vector r_{UE} of the second node with coordinates x_{UE}, y_{UE}, z_{UE} comprises r_{UE}=(x_{UE}, y_{UE}, z_{UE})^{T};
wherein normalizing the position vector of the second node is determined by:
$${\hat{r}}_{U E} = \frac{{r}_{U E}}{\vert {r}_{U E} \vert} = \frac{1}{\sqrt{{x}_{UE}^{2} + {y}_{UE}^{2} + {z}_{UE}^{2}}} ( \begin{matrix}{x}_{UE} \\ {y}_{UE} \\ {z}_{UE}\end{matrix} ) .$$

22. The method of claim 19, further comprising:
forming precoding matrices for the beams available in the MIMO antenna system using Kronecker product operation; and
computing a respective unit vector in the direction of the main lobe of radiation pattern resulting from applying the precoding matrix of each of the respective formed precoding matrices.

23. The method of claim 22, wherein the forming the precoding matrices is determined by:
Wᵢ=Kron(W_{H,m},W_{V,n}),i=1,2, . . . ,N_{PMI}
where Wᵢ, W_{H,m}, W_{V,n} are precoding matrices for a full-dimension, horizontal and vertical domains, respectively, and i is an indicator for the full-dimension precoding matrix associated to a pair (m, n), which indicator is a counting rule for precoding matrices;
wherein the respective computed unit vector is represented by:
\hat{r}_{PMI,i},i=1,2, . . . ,N_{PMI}

24. The method of claim 20, wherein the selecting the beam among the beams available in the MIMO antenna system comprises:
computing a scalar product based on the normalized position vector of the second node and a unit vector of each respective beam available in the MIMO antenna system;
wherein the beam being selected since the angle between the obtained direction and a main lobe direction of the beam that is selected provides the smallest angle among the beams available in the MIMO antenna system, is the beam where the scalar product is largest among the beams in the MIMO antenna system.

25. The method of claim 24:
wherein the scalar product is represented by a scalar product index; and
wherein the computing of the scalar product based on the normalized position vector of the second node for each respective beam available in the MIMO antenna system is performed by computing a scalar product index derived from:
sᵢ=\hat{r}_{UE}·\hat{r}_{B,i}=x_{UE}x_{B,i}+y_{UE}y_{B,i}+z_{UE}z_{B,i},i=1,2, . . . ,N_{B}
wherein sᵢ is the scalar product of beam with index i and N_{B} is the number of beams available in the MIMO antenna system; and
wherein the scalar product index of the selected beam is represented by:
$${i}_{s e l e c t e d} = \begin{matrix}arg max {s}_{i} \\ i\end{matrix} ;$$
wherein i_{selected} is the largest scalar product index of the selected beam among scalar product indexes of the available beams.

26. The method of claim 19, wherein:
the first node is represented by a network node, and the second node is represented by a User Equipment (UE); or
the first node is represented by a UE, and the second node is represented by a network node.

27. A non-transitory computer readable recording medium storing a computer program product for controlling first node for selecting a beam for a data transmission between a Multiple In Multiple Out (MIMO) antenna system used by the first node and a second node in a wireless communications system, the computer program product comprising program instructions which, when run on processing circuitry of the first node, causes the first node to:
obtain a direction from a reference point of the MIMO antenna system to the second node, based on location data defining a location of the second node;
select a beam among available beams in the MIMO antenna system for a subsequent transmission to or from the second node, wherein the beam that is selected is selected such that an angle between the obtained direction and a main lobe direction of the beam that is selected provides the smallest angle among the available beams in the MIMO antenna system.

28. A first node configured to select a beam for a data transmission between a Multiple In Multiple Out (MIMO) antenna system used by the first node and a second node in a wireless communications system, the first node comprising:
processing circuitry;
memory containing instructions executable by the processing circuitry whereby the first node is operative to:
obtain a direction from a reference point of the MIMO antenna system to the second node, based on location data defining a location of the second node;
select a beam among available beams in the MIMO antenna system for a subsequent transmission to or from the second node, which beam is selected such that an angle between the obtained direction and a main lobe direction of the beam that is selected provides the smallest angle among the available beams in the MIMO antenna system.

29. The first node of claim 28:
wherein the location data is comprises coordinates of the second node;
wherein the instructions are such that the first node is operative to obtain the direction by:
translating the coordinates of the second node into a position vector of the second node, and
normalizing the position vector of the second node to obtain the direction from the reference point of MIMO antenna system to the second node.

30. The first node of claim 29:
wherein the position vector r_{UE} of the second node with coordinates x_{UE}, y_{UE}, z_{UE} comprises r_{UE}=(x_{UE}, v_{UE}, z_{UE})^{T};
wherein the instructions are such that the first node is operative to normalize the position vector of the second node by determining it from:
$${\hat{r}}_{U E} = \frac{{r}_{U E}}{\vert {r}_{U E} \vert} = \frac{1}{\sqrt{{x}_{UE}^{2} + {y}_{UE}^{2} + {z}_{UE}^{2}}} ( \begin{matrix}{x}_{UE} \\ {y}_{UE} \\ {z}_{UE}\end{matrix} ) .$$

31. The first node of claim 28, wherein the instructions are such that the first node is operative to:
form precoding matrices for the beams available in the MIMO antenna system using Kronecker product operation; and
compute a respective unit vector in the direction of the main lobe of radiation pattern resulting from applying the precoding matrix of each of the respective formed precoding matrices.

32. The first node of claim 31, wherein the instructions are such that the first node is operative to form the precoding matrices by determining them from:
Wᵢ=Kron(W_{H,m},W_{V,n}),i=1,2, . . . ,N_{PMI}
where Wᵢ, W_{H,m}, W_{V,n} are precoding matrices for a full-dimension, horizontal and vertical domains, respectively, and i is an indicator for the full-dimension precoding matrix associated to a pair (m, n), which indicator is a counting rule for precoding matrices;
wherein the respective computed unit vector is represented by:
\hat{r}_{PMI,i},i=1,2, . . . ,N_{PMI}

33. The first node of claim 29, wherein the instructions are such that the first node is operative to select the beam among the beams available in the MIMO antenna system by:
computing a scalar product based on the normalized position vector of the second node and a unit vector of each respective beam available in the MIMO antenna system;
wherein the beam being selected since the angle between the obtained direction and a main lobe direction of the beam that is selected provides the smallest angle among the beams available in the MIMO antenna system, is the beam where the scalar product is largest among the beams in the MIMO antenna system.

34. The first node of claim 33:
wherein the scalar product is represented by a scalar product index;
wherein the instructions are such that the first node is operative to compute the scalar product based on the normalized position vector of the second node for each respective beam available in the MIMO antenna system, by computing a scalar product index derived from:
sᵢ=\hat{r}_{UE}·\hat{r}_{B,i}=x_{UE}x_{B,i}+y_{UE}y_{B,i}+z_{UE}z_{B,i},i=1,2, . . . ,N_{B}
wherein sᵢ is the scalar product of beam with index i and N_{B} is the number of beams available in the MIMO antenna system; and
wherein the scalar product index of the selected beam is represented by:
$${i}_{s e l e c t e d} = \begin{matrix}arg max {s}_{i} \\ i\end{matrix} ;$$
wherein i_{selected} is the largest scalar product index of the selected beam among scalar product indexes of the available beams.

35. The first node of claim 28, wherein:
the first node is represented by a network node, and the second node is represented by a User Equipment (UE); or
the first node is represented by a UE, and the second node is represented by a network node.
